(19) United States
(12) Patent Application Publication
(10) Pub. No.: US 2011/0169975 A1
(43) Pub. Date: Jul. 14, 2011

(54) IMAGE-SCANNING COMPUTATIONAL PIXEL RESOLVING CAMERA

(76) Inventor: Robert William Justice, Santa Monica, CA (US)

(21) Appl. No.: 12/685,864

(22) Filed: Jan. 12, 2010

(51) Int. Cl. H04N 5/228

(52) U.S. Cl. 348/222.1; 348/E05.032

(57) ABSTRACT

A method comprises: receiving a first light beam carrying a visual image; generating a plurality of second light beams based on the first light beam, wherein each of the plurality of second light beams is a subset of the first light beam; determining an energy level for each of the plurality of second light beams; and determining a single possible set of pixels that comprises the visual image carried by the first light beam based upon the determined energy level.

### BACKGROUND OF THE INVENTION

The present invention generally relates to a digital camera, more specifically an image-scanning computational pixel resolving camera that is able to capture an ultra-high resolution.

Currently, digital cameras sample the light that bounces off of a photographed subject and breaks that light pattern down into a series of pixel values. While current digital cameras can capture resolutions from one megapixel to five gigapixels, a digital camera may become more impractical and difficult to build as its resolution increases because current digital cameras use a sensor for each pixel of resolution that it captures.

As can be seen, what is needed is digital camera technology that makes it practical to design and build digital cameras that are able to capture an ultra-high resolution image using only a single sensor.

### SUMMARY OF THE INVENTION

In one aspect of the present invention, a method comprises: receiving a first light beam carrying a visual image; generating a plurality of second light beams based on the first light beam, wherein each of the plurality of second light beams is a subset of the first light beam; determining an energy level for each of the plurality of second light beams; and determining a single possible set of pixels that comprises the visual image carried by the first light beam based upon the determined energy level.

In another aspect of the present invention, a method comprises: receiving a first light beam carrying a visual image; splitting the first light beam into a second plurality of light beams; delaying portions of the second plurality of light beams so that all portions of the second plurality of light beams at once does not hit a sensor at a same time; progressively receiving at the sensor a subset of light beams from the second plurality of light beams; determining an energy level of each subset of light beam in the second plurality of light beams; and determining a single possible set of pixels that comprises the visual image carried by the first light beam based upon the determined energy level of each subset of light beam in the second plurality of light beams.

These and other features, aspects and advantages of the present invention will become better understood with reference to the following drawings, description and claims.

### BRIEF DESCRIPTION OF THE DRAWINGS

FIG. 1 shows an embodiment of an image-scanning computational pixel resolving camera in accordance with an embodiment of the present invention; and

FIG. 2 shows a flowchart of a method in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an image-scanning computational pixel resolving camera that is able to capture an ultra-high resolution image. Instead of using a sensor with millions of pixels in order to capture a high-resolution image, the digital camera in accordance with an embodiment of the present invention may use a single pixel sensor to capture an ultra high-resolution image that may exceed one trillion pixels in resolution.

Embodiments of the present invention may comprise a camera system that uses a single pixel sensor or sensor, but does not itself have any pixels in any part of its fundamental setup. Rather, the camera system may use any light-limiting method that prevents all of a light beam captured by the camera system from hitting a sensor at the same time, thus generating quantitative data describing regions of an image represented by the captured light.

In an exemplary embodiment, a light beam may be split into individual light beams that may each then be physically slanted in a plurality of directions, such as along a horizontal axis from side to side, along a vertical axis from top to bottom, from a diagonal axis from top-left to bottom-right, and from another diagonal axis from top-right to bottom-left.

A prism-shaped piece of glass may be used to prevent a totality of each of the individual light beam to hit a sensor all at once, a shutter may be used to block light from one side of an image carried upon the light wave to the other, or a rotating mirror may be used to reflect an image over an edge onto the sensor, thus generating ambiguity amongst the entire light wave carrying an image.

The ambiguity generated may be a low level of ambiguity that creates regional limitations, which may be any kind of limitation of incoming energy or general ambiguity on an abstract basis. The camera system may process the quantitative data describing regions of the image and use the data as computationally limiting factors in order to determine the only possible combination of pixels that may be resolved. Thus, instead of literally taking a picture, the camera system may generate limiting factors derived from the generated ambiguity of the captured light wave in order to provide to a processing system, such as a computer, a set of limitations in order to generate the only allowable dataset. In other words, the camera system may generate a low level of ambiguity and then reduce that ambiguity to produce a viewable set of coordinates and/or pixels.

The camera may use light, or any other form of energy that can be quantitatively described under the current and future laws of physics and mathematics. This includes but is not limited to matter carrying energy in any form, such as kinetic and thermal energy; the energy that mass itself is equal to; all electromagnetic radiation; magnetic fields; and anything existent within the universe that can be described quantitatively. Wherever the word light and similar are used in this application, any form of energy can be used equally in its place given proper modifications to the exact method used.

The ability to photograph anything existent is not what is being patented in this application, but rather the ability to photograph anything existent using the computational pixel resolving method described in this application. This is meant to elaborate that the method of taking a picture described in this application is not limited to only light and electromagnetic radiation, but can be used with anything quantitatively describable under any current or future laws of physics and mathematics. This is to say for example but not limited to that a version of the camera described in this application using a magnetically based sensor, and a version using a light based sensor, are equally covered under the intellectual rights provided by this patent. Anything that uses the computational pixel resolving method described in this application regardless of exact method is claimed to be covered under this patent.

To elaborate further on how the computational pixel resolving method functions and how broad this technology is; the camera described in this application may use any form of ambiguity generating system to accomplish its needs. What is said to be entirely non-ambiguous is if all of the light from the entity to be photographed were to hit a single sensor at once. This could be considered a “perfectly blurred image”. CCD and film based cameras generate ambiguity from this by placing points, what are commonly referred to as “pixels”, across the imaging plane so that regions of the image may immediately be distinguished from others, hence increasing ambiguity given more pixels. This essentially allows for segments of the image to not be mixed with others; partial elimination of this mixing allows for the ability to determine structure and shape within the image, making it intelligible. This is said to be ambiguity generated amongst the pixels generated; however within each pixel the light is said to be non-ambiguous and perfectly blurred. The camera being patented in this application does not initially generate pixel level ambiguity; instead it uses less ambiguous and more “blurred” light capturing methods, what may be initially construed from the raw data as a lower resolution image. The reason for this initially lower resolution and less ambiguous image capturing method is not for the absolute sake of requiring further advanced computation to form the image, but for the ability to use methods such as the prism, moving shutter and rotating mirror described elsewhere in this application. The ability to use these methods is what allows for the extreme levels of precision and speed not available to methods which immediately form an image using pixels. However, because the method described in this application does not immediately form enough ambiguity via intelligible data sets/pixels, further computation is required.

Take for example a CCD based camera with a resolution of 1 million pixels. For the camera described in this application to acquire the same resolution, using the method depicted in the drawings, known as the “spinning mirror method”, only 4000 data points would need to be resolved. 1000 on the X axis, 1000 on the Y axis, 1000 on the Z axis (top left to bottom right) and 1000 on the L axis (top right to bottom left). Given these determined data points, you can computationally resolve 1 million pixels. It is possible to use a similar technique to that described in the drawings within this application in order to immediately resolve the pixels data values without any computation, however this would take considerably longer and could not utilize a plurality of convenient methods available to the computationally pixel resolving camera. This is to say that a camera developed by an individual that uses the general structure of the spinning mirror method, but immediately develops the pixels/immediately generates the final level of ambiguity is not claimed to be covered under this patent. Only that which takes visually unintelligible initial data points, and uses them abstractly to generate pixels is said to be covered under this application.

Many CCD cameras and similar technologies do utilize computational methods to handle the data generated by the CCD, however, they only do so for the sake of for example but not limited to compiling the data into a convenient form such as a JPEG file, or making contrast and brightness adjustments. While the initial data set generated from the CCD may change, the outcome still possesses the same general color and structure of the initial data set. The computational pixel resolving camera's output after the computation will be indicative of the initial data set, however will bear no immediate intelligible resemblance.

The computational method used for the camera described in this application may be of any form; while the form insinuated to be used in this application uses a basic limiting system of which the data set acquired by the sensor is used as limiting factors for, this is not the only system being claimed to be possible. Any system which uses abstractly derived data points as a means to mathematically determine pixels via limitation of what pixels may be allowed to exist at their respectful points is claimed to be covered.

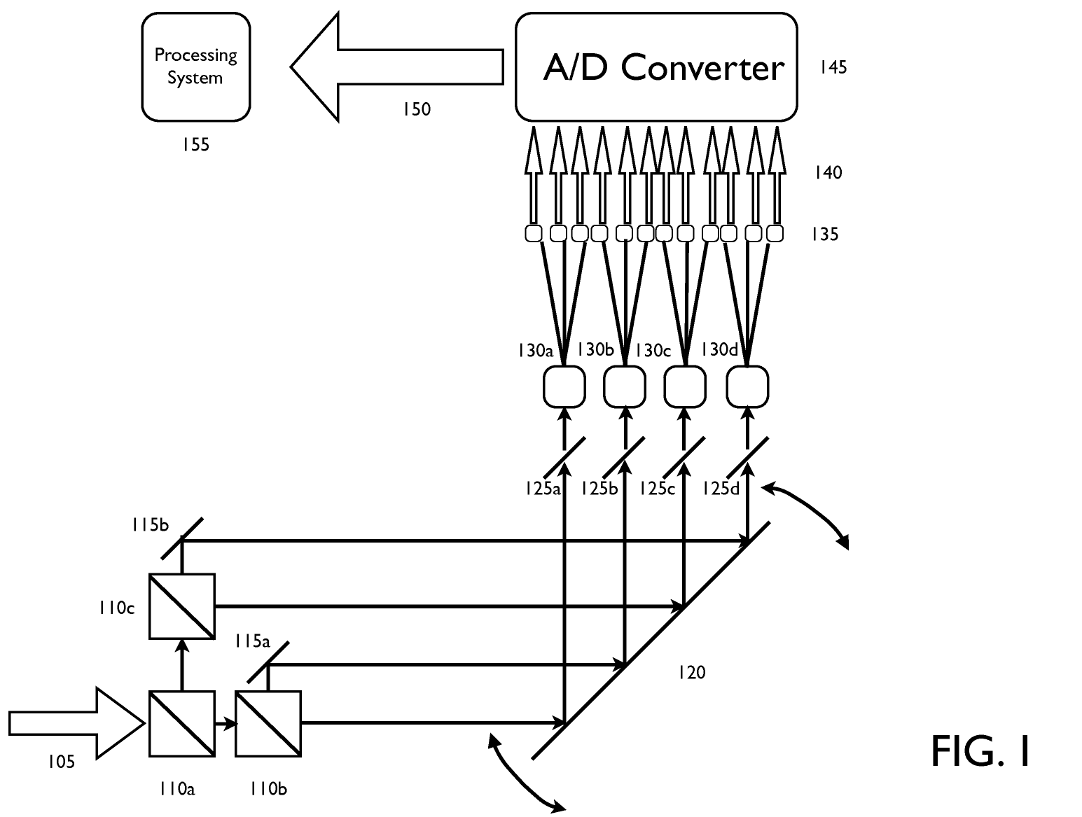

FIG. 1 shows an embodiment of an image-scanning computational pixel resolving camera in accordance with an embodiment of the present invention. As shown in FIG. 1, a basic camera lens (not shown) may collect and focus light, after which the light may be passed through a concave lens (not shown) that prevents further focusing or de-focusing and generates a parallel light beam wave 105. The light beam wave 105 may hit the three beam splitters 110a, 110b, and 110c, arranged so that the light beam wave 105 that hit the beam splitter 110a may be split into two light beam waves that are each split by a beam splitter 110b and 110c, thus splitting the light beam wave 105 into four beam waves. The mirrors 115a and 115b each redirects a wave coming out of a beam splitter 110b and 110c, respectively, so that in the end four parallel light beam waves may be generated out of the light beam wave 105.

The four parallel light beam waves may then travel to and reflect off of the spinning mirror 120. The spinning mirror 120 delays a portion of each of the four parallel light beam waves such that a sensor may not receive the entirety of a light beam wave at once. Instead, a sensor may first receive a first portion of a light beam wave and then after a delay receive the remaining portion of the light beam wave. At a certain point in its reflection arc, each of the four parallel light beam waves may reach an edge 125a, 125b, 125c, and 125d. The edges 125a, 125b, 125c, and 125d may be any sharp, smooth, and flat surface, such as like a razorblade. The four parallel light beam waves may move over the edges 125a, 125b, 125c, and 125d, and may reach trichroic beam splitters 130a, 130b, 130c, and 130d, which split each of the four parallel light beam waves into red, green, and blue components, thus generating twelve light beams.

The twelve light beams may now comprise three colors, and four orientations of slits, where the four orientations of slits may comprise a first orientation that limits light on a vertical axis from top to bottom, a second orientation that limits light on a horizontal axis from side to side, a third orientation that limits light on a diagonal axis from top left corner to bottom right corner, and a fourth orientation that limits light on a diagonal axis from top right corner to bottom left corner.

The twelve light beams may then each hit an individual photo diode 135. The photo diodes 135 may be conventional photo diodes that convert the light beams into voltage. The photo diodes 135 may convert the twelve light beams into voltage levels 140, and the voltage levels 140 may be converted by an analog-to-digital converter 145 into digital data 150. The digital data 150 may then be fed to a processing system 155 that determines the only possible set of pixels that can exist to make up an image carried by the light beam wave 105 in order to generate a digital version of the image carried by the light beam wave 105.

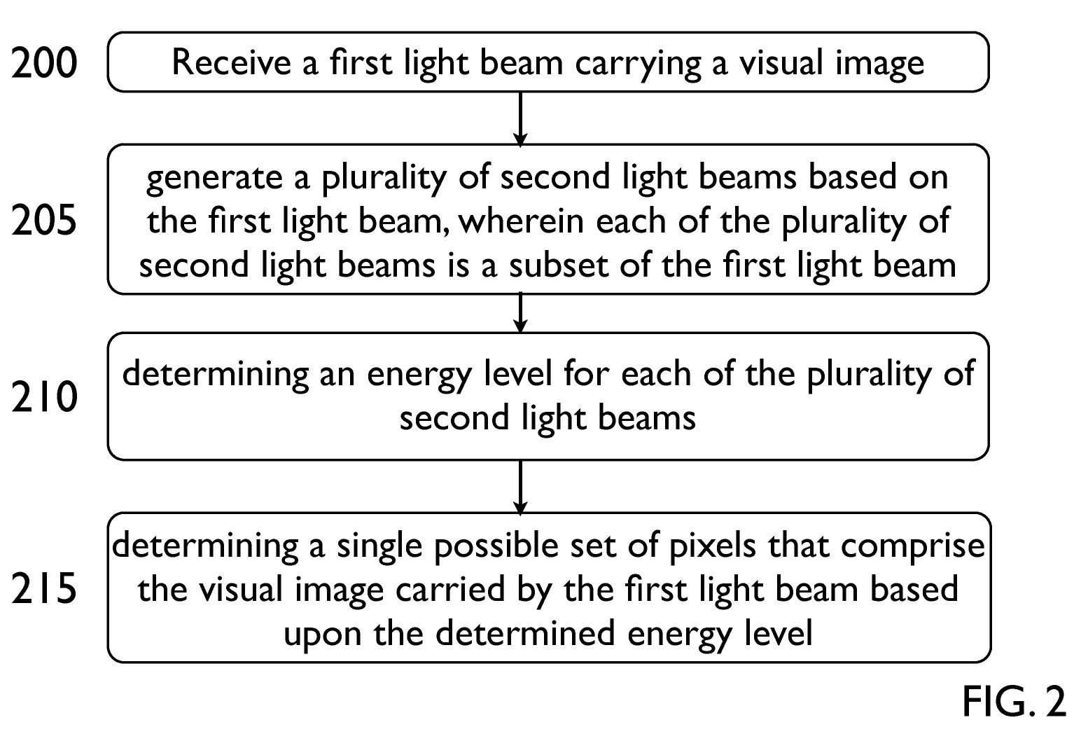

FIG. 2 shows a flowchart of a method in accordance with an embodiment of the present invention. At step 200, a first light beam carrying a visual image is received. At step 205, a plurality of second light beams based on the first light beam is generated; wherein each of the plurality of second light beams is a subset of the first light beam. At step 210, an energy level for each of the plurality of second light beams is determined. At step 215, a single possible set of pixels that comprises the visual image carried by the first light beam is determined based upon the determined energy level.

Besides light beams and the taking of photographs, alternate embodiments of the present invention may be used to take readings of any other forms of matter or energy besides light beams, such as a magnetic field, wind gusts, or any other forms matter or energy.

It should be understood, of course, that the foregoing relates to exemplary embodiments of the invention and that modifications may be made without departing from the spirit and scope of the invention as set forth in the following claims.

We claim:

1. A method comprising:
receiving a first light beam carrying a visual image;
generating a plurality of second light beams based on the first light beam, wherein each of the plurality of second light beams is a subset of the first light beam;
determining an energy level for each of the plurality of second light beams; and
determining a single possible set of pixels that comprises the visual image carried by the first light beam based upon the determined energy level.

2. The method of claim 1, wherein the determining the single possible set of pixels further comprises:
using the determined energy level as limiting factors in the determining of the single possible set of pixels.

3. The method of claim 1, wherein the generating the plurality of second light beams further comprises:
splitting the first light beam into a plurality of first light beams; and
delaying a portion of each of the plurality of first light beams so that a sensor progressively receives a light beam in the plurality of first light beams and does not receive at once a totality of the light beam in the plurality of first light beams.

4. The method of claim 1, wherein the plurality of second light beams comprises:
a third light beam comprising the first light beam light-limited on a vertical axis from top to bottom;
a fourth light beam comprising the first light beam light-limited on a horizontally axis from side to side;
a fifth light beam comprising the first light beam light-limited on a diagonal axis from top left corner to bottom right corner; and
a sixth light beam comprising the first light beam light-limited on a diagonal axis from top right corner to bottom left corner.

5. The method of claim 1, wherein the determining the energy level comprises:
dividing each of the plurality of second light beams into a plurality of regions; and
determining an energy level for each of the plurality of regions.

6. The method of claim 5, wherein the determining the energy level further comprises:
determining a voltage level for each of the plurality of regions.

7. A system comprising:
a beam splitter that receives a first light beam carrying a visual image and splits the first light beam into a second plurality of light beams;
a light wave delayer that delays each light beam in the second plurality of light beams so that that a sensor progressively receives a light beam in the second plurality of light beams and does not receive at once a totality of the light beam in the second plurality of light beams;
the sensor that progressively receives the light beam in the second plurality of light beams;
an energy measuring system that determines an energy level of each light beam in the second plurality of light beams; and
a processing system that determines a single possible set of pixels that comprises the visual image carried by the first light beam based upon the determined energy level of each light beam in the second plurality of light beams.

8. The system of claim 7, wherein the sensor receives a light beam comprising the first light beam light-limited on a vertical axis from top to bottom.

9. The system of claim 7, wherein the sensor receives a light beam comprising the first light beam light-limited on a horizontal axis from side to side.

10. The system of claim 7, wherein the energy measuring system determines a voltage level of each subset of light beam in the second plurality of light beams.

11. A method comprising:
passing energy through an energy limiting system;
receiving energy at sensor progressively;
converting output of sensor to digital data signal;
processing digital data signal through any plurality of systems with end goal of increasing ambiguity of the signal and converting to pixels;

12. The method of claim 11, wherein the energy may be any quantifiable entity.

13. The method of claim 11, wherein the sensor may be any system which alters state of said energy into computationally tangible form.

14. The method of claim 11, wherein the means to limit energy may be any system which accomplishes task of limiting or delaying totality of energy from reaching sensor simultaneously.

15. The method of claim 11, wherein said output conversion may be any necessary alteration of data required for processing of data.

16. The method of claim 11, wherein digital data signal may be any form of data indicative of initial said energy.

17. The method of claim 11, wherein processing method further comprises:
using regions of energy in the form of the digital data signal in order to limit the computer from generating a solid single color and brightness block of pixels, to forming a multicolor, brightness varying intelligible picture;
using the digital data signal to individually determine what each pixel comprising portions of the image may be through limitation of values that are mathematically allowed to exist within said pixel space;
using portions of the digital data signal that overlap or relate to particular pixels in order to determine what data values must exist in said pixel locations due to quantitative requirements set forth by the data;
fulfilling the required energy levels of regions from said digital data signal by creating pixels with energy values that satisfy but do not contradict quantitative requirements set forth by digital signal data;
creating pixels that cumulatively neither exceed or fail to add up to the required levels set forth by applicable regions of the digital data signal.
